(19) United States
(12) Patent Application Publication
(10) Pub. No.: US 2025/0262793 A1
(43) Pub. Date: Aug. 21, 2025

(54) METHOD OF MANUFACTURING A FIRE-RETARDANT TREATED WOOD COMPOSITE PANEL

(71) Applicant: LOUISIANA-PACIFIC CORPORATION, NASHVILLE, TN (US)

(72) Inventors: JIANWEN NI, FRANKLIN, TN (US); CHRIS ANDREWS, NASHVILLE, TN (US); DENNIS LUCAS, SOUTH BOSTON, VA (US)

(21) Appl. No.: 19/055,413

(22) Filed: Feb. 17, 2025

Related U.S. Application Data
(60) Provisional application No. 63/553,675, filed on Feb. 15, 2024.

(51) Int. Cl. B27N 9/00; B27N 3/04; B27N 3/08; B27N 3/12; B27N 7/00

(52) U.S. Cl. CPC B27N 9/00; B27N 3/04; B27N 3/083; B27N 3/12; B27N 7/005

(57) ABSTRACT

A process or method for manufacturing a fire-retardant treated wood composite board or panel, such as oriented-strand board, with a low melting point fire retardant (FR) material, such as boric acid, while the press is operating at typical press temperatures above the FR material melting point. An intervening overlay is applied to the top surface of the mat on the forming line, after the use or application of any FR material within or on the mat, prior to entry into the press. The intervening overlay covers the top surface so as to prevent the melting fire retardant material from contacting the press platen(s). After pressing, the intervening overlay may be removed from the top surface by sanding, buffing, or other methods. The intervening overlay also may be sized so as to extend over one or more edges of the underlying panel, for ease of removal post-process.

This application claims benefit of and priority to U.S. Provisional App. No. 63/553,675, filed Feb. 15, 2024, which is incorporated herein in its entirety by specific reference for all purposes.

### FIELD OF INVENTION

This invention relates to a process of manufacturing a fire-retardant treated wood composite panel, such as oriented-strand board (OSB), particleboard, medium density fiberboard (MDF), or other cellulose-based panels, with an intervening layer to prevent melted fire-retardant material from contacting press platens.

### BACKGROUND OF THE INVENTION

In general, wood-based composites include, but are not limited to, oriented-strand board (OSB), wafer board, flake board, particleboard, and fiberboard (e.g., medium density fiberboard, or MDF). These wood-based composites are typically formed from a wood element (e.g., flake, strand, particle, wafer) combined with a thermosetting adhesive to bind the wood substrate together. In some processes, other additives are added to impart additional properties to the wood composites. Additives may include fire retardants, fungicides, mildewcides, insecticides, and water repellents. A significant advantage of strand and particle-based wood composites is that they have many of the properties of plywood and dimensional lumber, but can be made from a variety of lower grade wood species, smaller trees and waste from other wood product processing. In addition, they can be formed into panels in lengths and widths independent of the size of the harvested timber.

One class of wood-based composites products comprise multilayer, oriented wood strand panel products. These oriented-strand, multilayer composite wood panel products are composed of several layers of thin wood strands, which are wood particles having a length which is several times greater than their width. These strands are created from debarked round logs by placing the edge of a cutting knife parallel to a length of the log and then slicing thin strands from the log. The result is a strand in which the fiber elements are substantially parallel to the strand length. These strands can then be oriented on a mat-forming line with the strands of the outer face layers predominantly oriented in a parallel-to-machine direction, and strands in the core layer generally oriented perpendicular to the face layers (i.e., “cross-machine”) direction.

In one known commercial process, these mat layers are bonded together using natural or synthetic adhesive resins under heat and pressure to make the finished product. Oriented, multilayer wood strand panels of the above-described type can be produced with mechanical and physical properties comparable to those of commercial softwood plywood and are used interchangeably, such as for wall and roof sheathing. In certain types of construction, these wood-based panels (and other construction materials) may be required by building codes to meet certain durability requirements, such as fire, wind and water resistance.

Oriented, multilayer wood strand panels and similar products of the above-described type, and examples of processes for pressing and production thereof, are described in detail in U.S. Pat. Nos. 3,164,511, 4,364,984, 5,435,976, 5,470,631, 5,525,394, 5,718,786, and U.S. Pat. No. 6,461,743, all of which are incorporated herein in their entireties by specific reference for all purposes.

Some wood panel products (e.g., fire-retardant treated plywood) are treated with fire retardants, which are activated and catalyze the dehydration of cellulose when exposed to heat during a fire event. This reaction converts wood into water and “char” (i.e., partially-burned wood or charcoal), and reduces the susceptibility of the wood to continuous combustion.

While effective for imparting fire retardancy to wood, these fire retardants may be susceptible to premature activation. For example, some fire retardants could be activated under the high heat and high humidity in an attic space during summer, which would degrade the mechanical strength of wood structural panels. Various fire-retardant formulations have developed to address this issue. For, example, U.S. Pat. No. 4,373,010 (which is incorporated herein in its entirety by specific reference for all purposes) describes several liquid fire retardants that contain guanylurea phosphate (GUP) and boric acid. Similarly, U.S. Pat. No. 10,703,009 (which is incorporated herein in its entirety by specific reference for all purposes) describes an aqueous boric acid dispersion.

These fire retardants, however, will not properly work with wood-based panels, such as OSB, due to the high temperatures of the press during the manufacturing process. OSB typically is manufactured using press temperatures ranging from approximately 190° C. to approximately 220° C. Boric acid has a melting point of 170.9° C., which is below these press temperatures, so it will soften and melt while at higher temperatures, and its use during the OSB manufacturing process thus will result in build-up of the melted material in the press itself. This can cause the FR treated OSB blanks, board, or panels to stick to the press platens during the manufacturing process.

One approach to address this issue is to press the panels at a temperature below the FR melting point. U.S. patent application Ser. No. 18/109,036 (filed Feb. 13, 2023), published as U.S. Pub. No. 2023/0256648 (published Aug. 17, 2023), which is incorporated herein by specific reference for all purposes, discloses a method of manufacturing a fire-retardant tread wood composite panel, such as OSB, with low melting point fire retardant material by reducing the press temperature to below the melting point or softening temperature of the fire retardants noted above. However, lower temperature pressing can negatively impact manufacturing productivity. Another alternative is to apply a release agent on top of the strand mat prior to pressing; however, coverage of the release agent on the mat surface is critical and is often unreliable and/or inconsistent.

### SUMMARY OF INVENTION

In various exemplary embodiments, the present invention comprises a process of manufacturing a fire-retardant treated wood composite board or panel (e.g., OSB) with a low melting point fire retardant or fire resistant (FR) material, such as, but not limited to, boric acid, while the press is operating at typical press temperatures (i.e., above the FR material melting point). An intervening overlay is applied to the top surface of the mat on the forming line, after the use or application of any fire-retardant material within or on the mat, prior to entry into the press. The intervening overlay covers all or substantially all of the top surface so as to prevent the melting low melting fire retardant material from contacting the press platen(s). The intervening overlay is made of suitable material able to withstand the application of heat and pressure while in the press.

After the pressing of the panel, the intervening overlay may be removed from the top surface by sanding, buffing, or similar means. In several embodiments, the intervening overlay is sized so as to extend over one or more edges of the underlying panel, for ease of removal post-process. In some embodiments, the overlay may be left on the top surface, and the panel subsequently processed as normal for an FRT panel.

### BRIEF DESCRIPTION OF THE DRAWINGS

FIG. 1 shows a diagram for a press production/manufacturing process for an OSB panel product in accordance with the present invention.

FIG. 2 shows a diagram of an alternative embodiment of a press production/manufacturing process for an OSB panel product in accordance with the present invention.

FIG. 3 shows a diagram of another alternative embodiment of a press production/manufacturing process for an OSB panel product in accordance with the present invention.

FIG. 4 shows a diagram of yet another alternative embodiment of a press production/manufacturing process for an OSB panel product in accordance with the present invention.

FIG. 5 shows a cross-section of a pre-press strand mat with fines layer and intervening overlay.

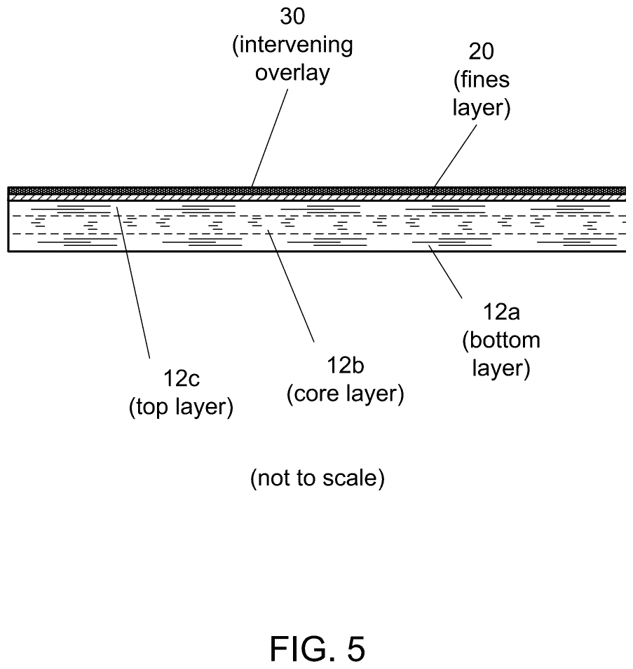

FIG. 6 shows a cross-section of a pre-press strand mat with fines layer and intervening overlay with a portion of the intervening overlay extending beyond an edge of the mat with fines layer.

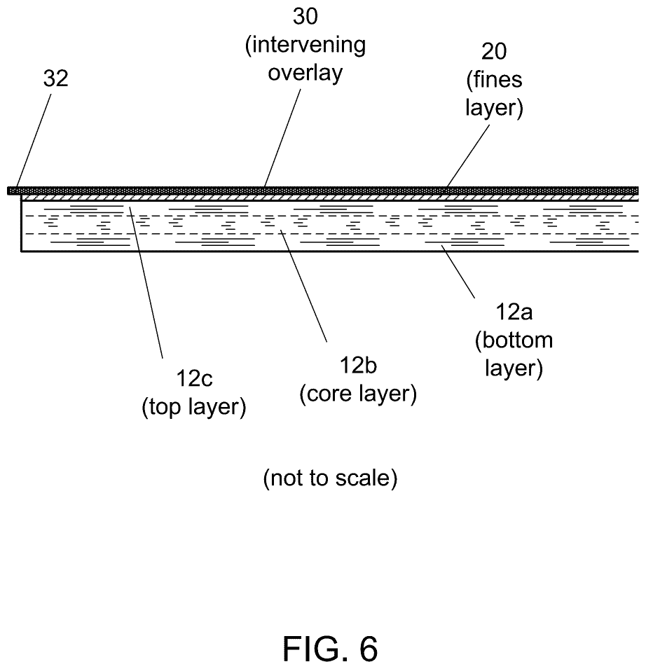

### DESCRIPTION OF EXEMPLARY EMBODIMENTS OF THE INVENTION

In various exemplary embodiments, the present invention comprises a method or process of manufacturing a fire-retardant treated wood composite or manufactured wood panel or board (e.g., OSB) with low melting point fire retardant (FR) material, such as, but not limited to, boric acid, while the press is operating at typical press temperatures (i.e., above the FR material melting point). For example, OSB typically is manufactured using press temperatures ranging from approximately 190°° C. to approximately 220° C. Boric acid has a melting point of 170.9° C., which is below these press temperatures, so it will soften and melt while at typical press temperatures, and its use during the OSB manufacturing process thus will result in build-up of the melted material in the press itself.

In accordance with the present invention, an intervening overlay 30 is applied to the top surface of the mat on the forming line, after the use or application of any fire-retardant material within or on the mat, prior to entry into the press. The intervening overlay covers all or substantially all of the top surface of the strand mat 12a,b,c, and any fines layer 20, so as to prevent the melting low melting fire retardant material from contacting the press platen(s). The intervening overlay is made of suitable material able to withstand the application of heat and pressure while in the press.

After the pressing of the panel, the intervening overlay 30 may be removed from the top surface by sanding, planing, buffing, brushing with a wire brush, pressure washing or spraying, or similar means. In several embodiments, the intervening overlay is a “peel-off”' overlay, with the lower face of the overlay comprising a coating or layer to resist adhesion to the mat during pressing.

The “peel-off” overlay may be slightly larger than the underlying panel, sized so as to extend over 32 one or more edges of the underlying panel for ease of removal post-press. In further embodiments, the overlay may be left on the top surface, and the panel subsequently processed as normal for an FRT panel.

The intervening overlay may comprise paper, kraft paper, or other similar material. It may match one or more dimensions of the underlying strand mat and/or its top surface. That is, the intervening overlay may have the same width and length as the strand mat and/or its top surface, or may vary slightly in one or both. In one embodiment, as described above, the length and/or width of the intervening overlay may be greater, so that one or more edges of the intervening overlay extend beyond the underlying strand mat and/or top surface. The thickness of the intervening overlay may vary depending on the press conditions, the size of the strands in the mat, the presence of a fines layer, the type of FR material used, the intended end use of the product, or similar factors, or combinations thereof. In one embodiment, the intervening overlay is 3/16″ thick or less. In another embodiment, the intervening overlay is ¼″ thick or less. In a further embodiment, the intervening overlay is 1/16″ or less. In yet a further embodiment, the intervening overlay is 1/32″ or less.

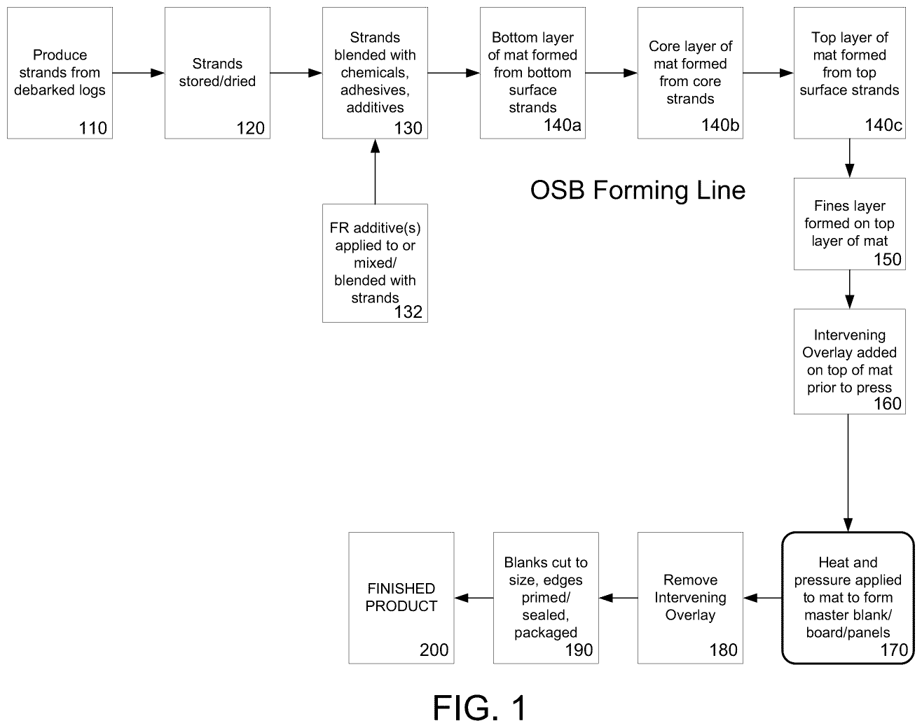

FIG. 1 shows an example of the method of the present invention. Strands are produced from debarked logs 110 and dried and stored 120. The strands are then blended with resins, adhesives, and/or other chemicals 130. Low melting point fire-retardant material is mixed with or applied to the strands 132, either with the blending with resins, adhesives and/or other chemicals 130, or separately before or after the blending. The treated strands are then used to form multiple layers (e.g., bottom layer 140a, core layer 140b, top layer 140c) on a forming line. Strands used to form multiple layers may be treated together, or may be treated separately, so that strands in different layers may comprise different types and/or amounts or concentrations of FR material.

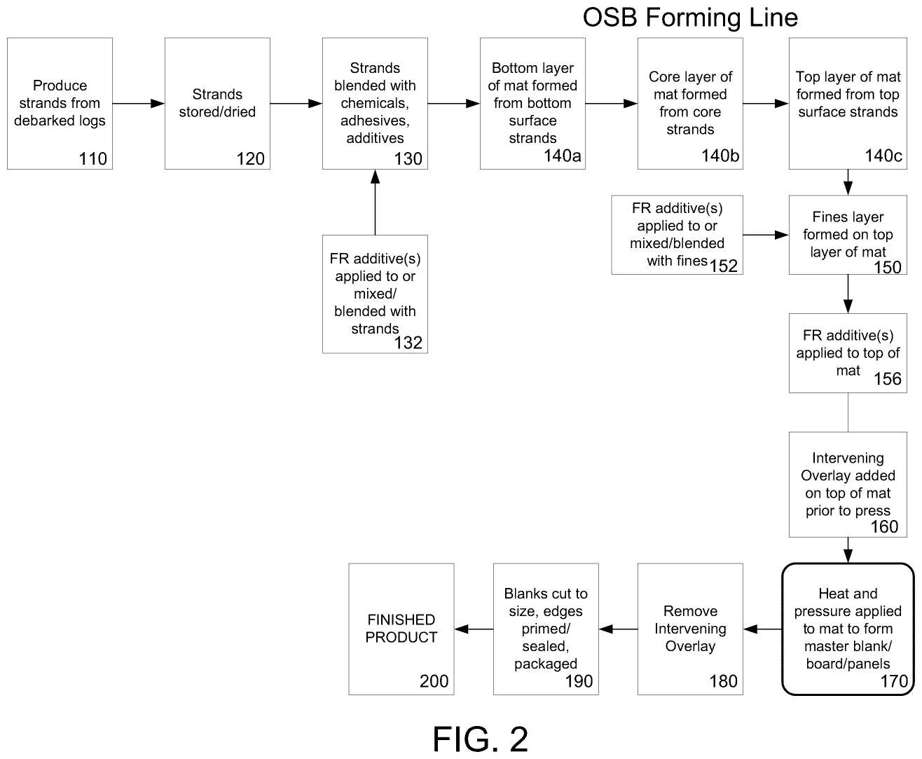

An optional fines layer 150 may be added to the upper surface of the strand mat, as is known in the prior art. The fines layer may not have any FR treatment, as seen in FIG. 1, although it some embodiments, as seen in FIG. 2, FR material may be mixed with or applied to the wood particles or material making up the fines layer 152.

After the mat is formed, the intervening overlay is applied 160 on top of the mat, and any fines layer, and the mat and intervening overlay then enter the press and subjected to heat and pressure to form master panels, boards or “blanks” 170. After removal from the press, the intervening overlay is removed 180 as described above (e.g., peel-off, sanding, planing, buffing, brushing with a wire brush, pressure washing or spraying, or similar means). The master blanks/board/panels are then trimmed or cut to the desired size(s) (e.g., a master can be trimmed, cut or divided in multiple panels or boards of typical sizes sold in the marketplace, such as 4′×8′ panels), with surfaces and/or edges primed and/or sealed, and packaged 190 to produce the finished product 200. Due to the use of the removable intervening overlay, no release agents or similar treatments to prevent the buildup of resin and/or FR material on the platens need to be applied prior to or during the pressing process. The present invention thus replaces the use of release agents, or the need to lower press temperatures.

FIG. 2 shows a variation of the method of FIG. 1, where FR material is applied to or mixed or blended with the fines material 152 prior to formation of the fines layer 150 on top of the strand mat. FR material also may be applied to the top of the strand mat (with or without a fines layer or other similar layers) 156. While FIG. 2 shows FR material being added at three points in the process, a person of skill in the art would understand that a process could add material at any one of these points alone, or any combination of these points. For example, FR material could be applied only to the top of the strand mat 156. The addition of the intervening overlay after the application to FR material in all of these cases serves to prevent the buildup of the FR material on the press platen(s).

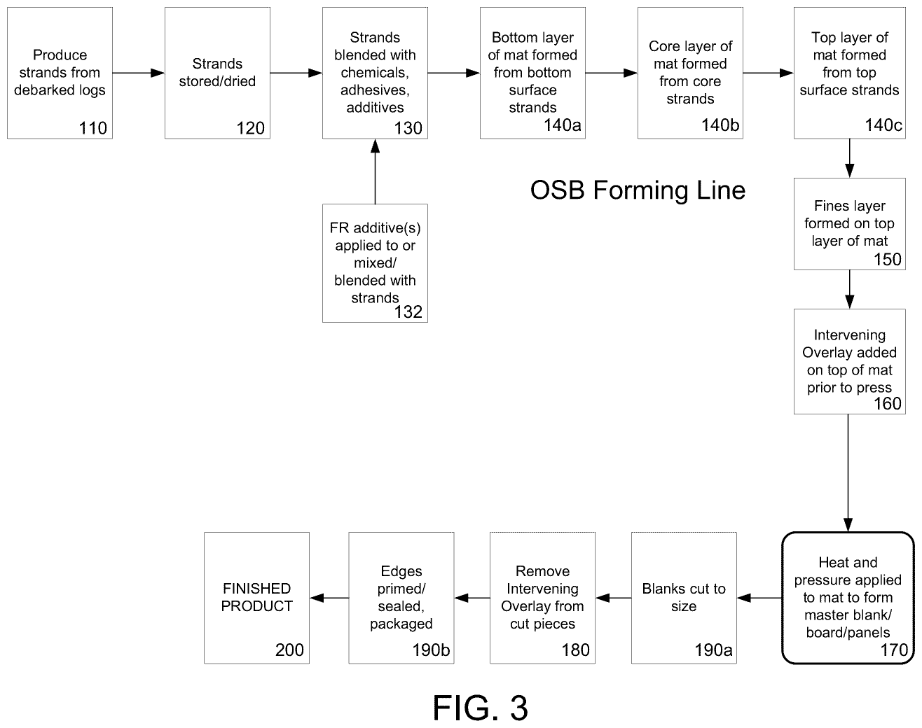

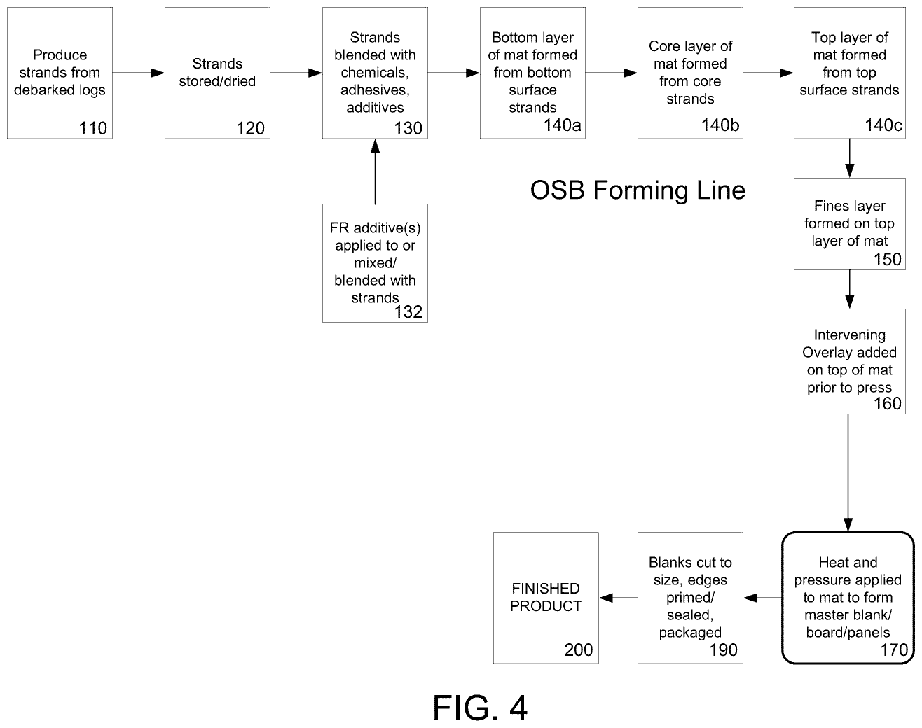

FIGS. 3 and 4 show variations in post-press steps of the method of FIG. 1. In FIG. 3, after removal from the press, the master blanks/board/panels are first trimmed or cut to the desired size 190a, the intervening overlay then is removed 180 from the cut pieces, and the cut. The master blanks/board/panels are then trimmed or cut to the desired size(s), with surfaces and/or edges primed and/or sealed, and packaged 190b to produce the finished product 200. In FIG. 4, the intervening overlay is not removed.

In several embodiments, the present invention thus comprises a process for manufacturing a fire-retardant treated wood composite board or panel, comprising the steps of:
blending a plurality of wood strands with one or more chemicals or adhesives;
apply a fire-retardant material to at least some of said plurality of wood strands;
forming, on a forming line, a multi-layer strand mat from said plurality of wood strands, said multi-layer strand mat comprising a top surface;
placing an intervening overlay layer on the top surface of the multi-layer strand mat;
in a press, applying heat and pressure to the multi-layer strand mat and intervening overlay layer to form a master blank, panel or board;
after removing the master blank, panel or board from the press, removing the intervening overlay layer from the top surface.

The process may further comprise the step of adding a fines layer to the multi-layer strand mat as the top surface, and the fines layer comprising fire-retardant material. The process may further comprise the step of applying a second fire-retardant material to the top surface prior to placing the intervening overlay on the top surface. The process may further comprise, as the steps of removing the intervening overlay layer, the steps of planing or sanding the intervening overlay layer from the top surface, pressure-washing the intervening overlay layer from the top surface, and/or peeling the intervening overlay layer from the top surface. To assist in the step of peeling, the intervening overlay layer may comprise an adhesive-resistant coating or layer on the face in contact with the top surface. Further, the intervening overlay layer and the top surface may have the same length and width. Alternatively, one or more edges of the intervening overlay layer may extend beyond a corresponding edge or edges of the top surface.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A process for manufacturing a fire-retardant treated wood composite board or panel, comprising the steps of:
blending a plurality of wood strands with one or more chemicals or adhesives;
apply a fire-retardant material to at least some of said plurality of wood strands;
forming, on a forming line, a multi-layer strand mat from said plurality of wood strands, said multi-layer strand mat comprising a top surface;
placing an intervening overlay layer on the top surface of the multi-layer strand mat;
in a press, applying heat and pressure to the multi-layer strand mat and intervening overlay layer to form a master blank, panel or board;
after removing the master blank, panel or board from the press, removing the intervening overlay layer from the top surface.

2. The process of claim 1, further comprising the step of adding a fines layer to the multi-layer strand mat as the top surface.

3. The process of claim 2, wherein the fines layer comprises fire-retardant material.

4. The process of claim 1, further comprising the step of applying a second fire-retardant material to the top surface prior to placing the intervening overlay on the top surface.

5. The process of claim 1, wherein the step of removing the intervening overlay layer comprises planing or sanding the intervening overlay layer from the top surface.

6. The process of claim 1, wherein the step of removing the intervening overlay layer comprises pressure-washing the intervening overlay layer from the top surface.

7. The process of claim 1, wherein the step of removing the intervening overlay layer comprises peeling the intervening overlay layer from the top surface.

8. The process of claim 7, wherein the intervening overlay layer comprises an adhesive-resistant coating or layer on the face in contact with the top surface.

9. The process of claim 1, wherein the intervening overlay layer and the top surface have a same length and width.

10. The process of claim 1, wherein one or more edges of the intervening overlay layer extend beyond a corresponding edge or edges of the top surface.

11. The process of claim 1, wherein the intervening overlay layer comprises paper.

12. The process of claim 1, wherein the intervening overlay layer comprises kraft paper.

13. The process of claim 1, wherein the intervening overlay layer has a thickness of from approximately 1/16 inch to ¼ inch.

14. The process of claim 1, wherein the intervening overlay layer has a thickness of from approximately 1/16 inch to 3/16 inch.

15. The process of claim 1, wherein the intervening overlay layer has a thickness of 1/16 inch or less.
